(19) United States
(12) Patent Application Publication
(10) Pub. No.: US 2010/0309146 A1
(43) Pub. Date: Dec. 9, 2010

(54) TOUCH PANEL AND DISPLAY DEVICE

(76) Inventors: Yuet-Ping Lee, Hsin-Chu (TW); Yao-Jen Hsieh, Hsin-Chu (TW); Heng-Sheng Chou, Hsin-Chu (TW); Pang-Chiang Chia, Hsin-Chu (TW); Chao-Chen Wang, Hsin-Chu (TW); Yu-Cheng Tsai, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/554,984

(22) Filed: Sep. 8, 2009

(30) Foreign Application Priority Data
Jun. 5, 2009 (TW) 098118691

(51) Int. Cl. G06F 3/041

(52) U.S. Cl. 345/173

(57) ABSTRACT

A touch panel includes at least a warning sensor. When an external force applied onto the touch panel reaches a predetermined strength so as to contact a top warning electrode to a bottom warning electrode, the warning sensor will be turned on in order to warn the user to reduce the external force so as to prevent the touch panel from being damaged by the external force.

### BACKGROUND OF THE INVENTION

1. The Field of the Invention

This present invention relates to a touch panel, and more particularly, to a touch panel with at least a warning sensor for sensing external forces.

2. The Description of the Prior Art

Currently, in the market of various kinds of consumer electronic products, touch panels have been widely applied in portable electronic devices such as personal digital assistants (PDA), mobile phones, and notebooks for serving as the interface of information communication tool between the users and the electronic devices. Since modern electronic products increasingly become smaller, thinner, and lighter, the display with a touch panel has gradually become the key component of various electronic products in order to save space and to replace traditional input apparatuses, such as operation buttons, keyboard, and mouse, leaning on the trend of requirement of human-based designed flat computer.

According to the operation method of the conventional touch panel, when the user presses or touches the surface of the panel with his finger, the pressed point will have a voltage variation such that the location of the pressed point can be calculated in accordance with the quantity of voltage variation. Sequentially, an input signal representing the location of the pressed point can be transferred through a conductive material to further control the electronic device. However, sometimes the user may apply too large external force such that the inner sensing elements in the touch panel may be damaged, causing sensing error or destroying the touch panel. Therefore, how to prevent the user from applying too large external force to damage the touch panel or cause sensing error during operation is still an unsolved problem for the manufacturer.

### SUMMARY OF THE INVENTION

It is one of the primary objectives of the present invention to provide a touch panel having at least a warning sensor for sensing the strength of external force, so as to solve the above-mentioned problem that too large external force may affect the operation performance of the touch panel in the prior art.

According to the claimed invention, the claimed invention provides a touch panel comprising an upper substrate and a lower substrate in parallel with each other, at least a touching sensor, and at least a warning sensor. The touching sensor comprises a top touching electrode and a bottom touching electrode respectively disposed on the bottom surface of the upper substrate and the top surface of the lower substrate, wherein the bottom touching electrode corresponds to the top touching electrode. The top touching electrode and the bottom touching electrode have a first sensor gap therebetween. The warning sensor comprises a top warning electrode and a bottom warning electrode respectively disposed on the bottom surface of the upper substrate and the top surface of the lower substrate, and the bottom warning electrode corresponds to the top warning electrode. The top warning electrode and the bottom warning electrode have a second sensor gap therebetween, and the second sensor gap is larger than the first sensor gap. When an external force applied onto the touch panel of the present invention reaches a predetermined strength, the top warning electrode will contact the bottom warning electrode to make the warning sensor output a readout signal for indicating the external force is too large.

According to the claimed invention, a display device is further provided. The display device comprises a touch display panel, a readout circuit unit, and a warning circuit unit. The touch display panel comprises an upper substrate and a lower substrate in parallel with each other, at least a touching sensor, and at least a warning sensor. The touching sensor comprises a top touching electrode disposed on the bottom surface of the upper substrate and a bottom touching electrode disposed on the top surface of the lower substrate, corresponding to the top touching electrode. The top touching electrode and the bottom touching electrode have a first sensor gap therebetween. The warning sensor comprises a top warning electrode disposed on the bottom surface of the upper substrate and a bottom warning electrode disposed on the top surface of the lower substrate and corresponding to the top warning electrode. The top warning electrode and the bottom warning electrode have a second sensor gap therebetween, and the second sensor gap is larger than the first sensor gap. When an external force applied onto the touch panel reaches a predetermined strength, the top warning electrode will contact the bottom warning electrode and the warning sensor will output a readout signal. In addition, the readout circuit unit is used for receiving the readout signal and outputting a feedback signal, and the warning circuit unit will control the touch display panel to produce a warning signal for indicating that the external force is too large after it receives the feedback signal.

According to the claimed invention, an in-cell touch panel is even provided. The in-cell touch panel comprises an upper substrate and a lower substrate in parallel with each other, a display material layer disposed between the upper and lower substrates, a plurality of pixel structures, at least a touching sensor, and at least a warning sensor. The lower substrate comprises a display area, and the pixel structures are disposed in the display area. Each pixel structure comprises a gate line, a data line, and a thin film transistor (TFT), wherein the gate line and the data line are disposed on the lower substrate and the TFT is electrically connected to the gate line and data line. The touching sensor comprises a top touching electrode and a bottom touching electrode respectively disposed on the bottom surface of the upper substrate and on the top surface of the lower substrate. The bottom touching electrode corresponds to the top touching electrode. The top touching electrode and the bottom touching electrode have a first sensor gap therebetween. The warning sensor comprises a top warning electrode and a bottom warning electrode, wherein the top warning electrode is disposed on the bottom surface of the upper substrate, and the bottom warning electrode is disposed on the top surface of the lower substrate and corresponds to the top warning electrode. The top warning electrode and the bottom warning electrode have a second sensor gap therebetween, and the second sensor gap is larger than the first sensor gap. When an external force applied onto the in-cell touch panel reaches a predetermined strength, the top warning electrode will contact the bottom warning electrode to make the warning sensor output a readout signal to indicate the external force is too large.

It is an advantage that the touch panel of the claimed invention comprises a warning sensor which is turned on to output the readout signal when the external force applied onto the touch panel is too large, such that the user can be warned to reduce the external force in order to prevent the touch panel from being damaged by large external force.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the top view of a first embodiment of the display device according to the present invention.

FIG. 2 is a partial sectional schematic diagram of the touch panel shown in FIG. 1.

FIG. 3 is a schematic diagram of the top view according to a second embodiment of the display device of the present invention.

FIG. 4 is an equivalent circuit diagram of the pixel region shown in FIG. 3.

FIG. 5 is a schematic diagram of the element layout according to a third embodiment of the display device of the present invention.

FIG. 6 is a schematic diagram of the sectional view of the touch panel shown in FIG. 5

FIG. 7 is a schematic diagram of an embodiment of the display device showing a warning signal to indicate the external force is too large according to the present invention.

FIG. 8 is a schematic diagram of the element layout according to a fourth embodiment of the display device of the present invention.

FIG. 9 is an equivalent circuit diagram of a pixel structure according to a fifth embodiment of the touch panel of the present invention.

FIG. 10 is an equivalent circuit diagram of a pixel structure according to a sixth embodiment of the touch panel of the present invention.

### DETAILED DESCRIPTION

According to the spirit of the present invention, at least a warning sensor is disposed in the touch panel. Therefore, when an external force applied onto the surface of the touch panel is too large or too strong, the warning sensor will be turned on to produce a readout signal or a warning signal in cooperation with other control units to perform a warning mechanism in order to warn the user and prevent the user from keeping on applying too strong external force to damage the touch panel.

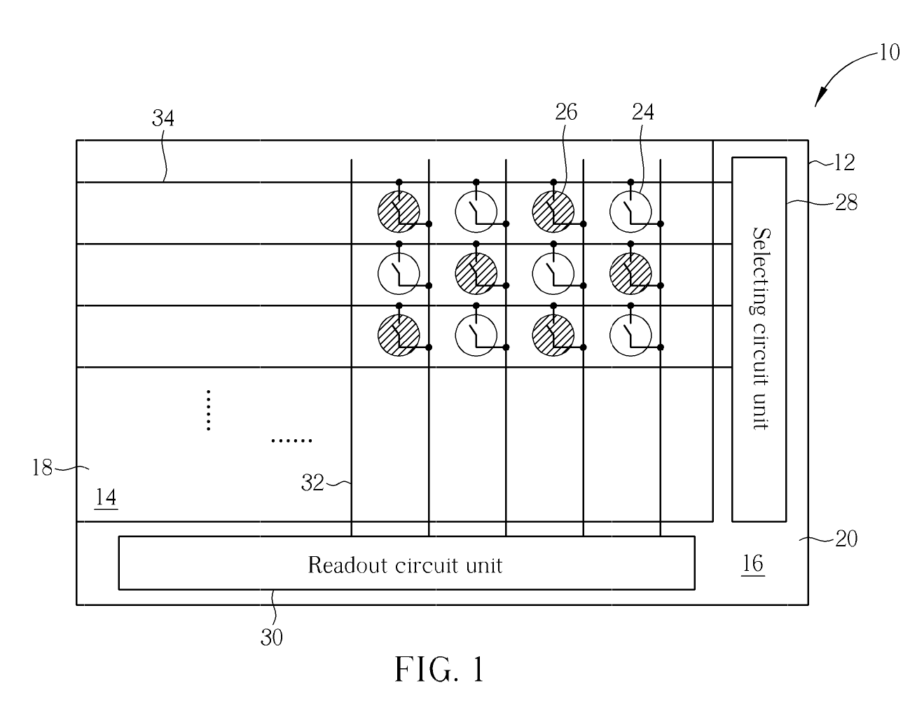

With reference to FIG. 1, FIG. 1 is a schematic diagram of the top view of a first embodiment of the display device according to the present invention. The display device 10 of the present invention comprises a touch panel 12, wherein the touch panel 12 may be attached on the surface of a display panel. However, in other embodiments, the touch panel 12 may be an in-cell touch panel which is a touch display panel. The touch panel 12 of this embodiment comprises an upper substrate 14 and a lower substrate 16 disposed in parallel with each other. The overlap portion of the upper substrate 14 and the lower substrate 16 is defined as a touch area 18, and the portion of the lower substrate 16 not overlapped by the upper substrate 14 is defined as a periphery circuit area 20. The touch panel 12 further comprises at least a touching sensor 26 and at least a warning sensor 24 that are similar to each other. In a preferable embodiment, the touch panel 12 comprises a plurality of touching sensors 26 and a plurality of warning sensors 24, disposed distributively in the touch area 18. The touch panel 12 further comprises a plurality of readout lines 32 and a plurality of selecting lines 34 crossing with each others. Each touching sensor 26 and each warning sensor 24 are electrically connected to a readout line 32 and a selecting line 34 respectively.

The display device 10 of the present invention further comprises a selecting circuit unit 28 and a readout circuit unit 30, preferably disposed on the touch panel 12, for instance disposed in the periphery circuit area 20. However, in other embodiments, the selecting circuit unit 28 and the readout circuit unit 30 may be disposed on external circuit boards and electrically connected to the touching sensors 26 and warning sensors 24 on the touch panel 12 through the external circuit boards. Since the readout lines 32 and the selecting lines 34 are electrically connected to the readout circuit unit 30 and the selecting circuit unit 28 respectively, when the touching sensors 26 or warning sensors 24 are conducted or turned on caused by a touch or pressing of an external force, they will respectively produce or output a readout signal, such as a DC voltage signal, which will be transferred to the readout circuit unit 30 through the readout lines 32. Dissimilarly, the readout signals outputted by the touching sensors 24 is used for serving as touch-control instructions, while the readout signals outputted by the warning sensor 26 are used for making the readout circuit unit 30 or other control units produce warning signals. In this embodiment, the touching sensors 26 and the warning sensors 24 are disposed intermixedly or alternatively in the touch panel 12, wherein the touching sensors 26 and the warning sensors 24 in the same column are all electrically connected to the same readout line 32, and the touching sensors 26 and the warning sensors 24 in the same row are all electrically connected to the same selecting line 34. However, in other embodiments, the arrangement of the touching sensors 24 and warning sensors 26 may be various and not limited to the disclosure in FIG. 1. For example, the touching sensors 26 may be arranged as several columns or rows which only contain the touching sensors 26 but without any warning sensors 24, while the warning sensors 24 may be arranged as other columns or rows only contain the warning sensors 24 without any touch sensor 26. Meanwhile, the columns or rows of the touching sensors 26 and the columns or rows of the warning sensors 24 may be placed alternatively. Therefore, the touching sensors 26 and the warning sensors 24 may not be electrically connected to the same readout lines 32 or selecting lines 34. Furthermore, the amount of the warning sensors 24 may be less than that of the touching sensors 26. For example, the touching sensors 26 may be two or more times as many as the warning sensors 24 are, which means every two or more touching sensors 26 will have one warning sensors 24 located nearby in the touch panel 12.

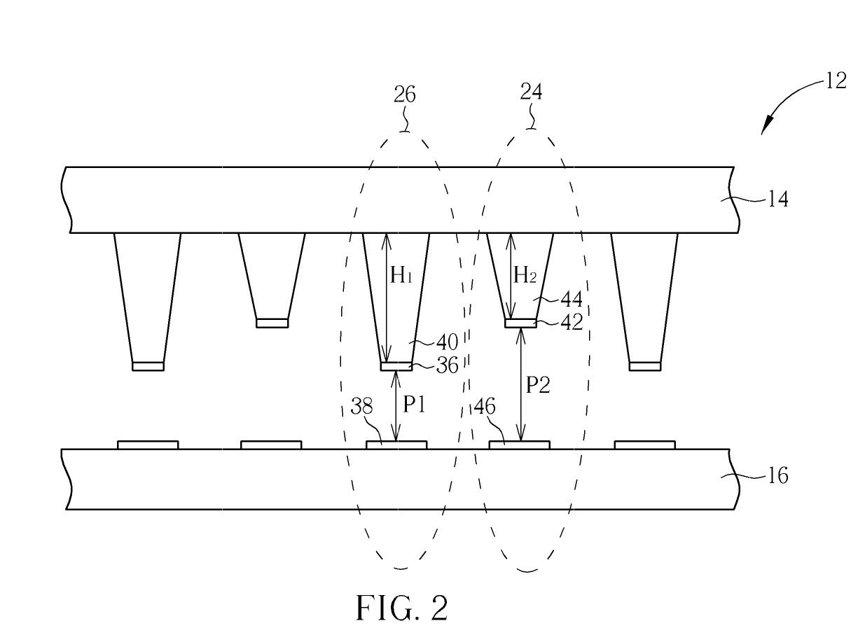

Referring to FIG. 2, FIG. 2 is a partial sectional schematic diagram of the touch panel 12 shown in FIG. 1. The touching sensors 26 and warning sensors 24 are disposed between the upper and lower substrates 14, 16, wherein each touching sensor 26 comprises a top touching electrode 36 and a bottom touching electrode 38 respectively disposed on the bottom surface of the upper substrate 14 and the top surface of the lower substrate 16, which correspond to each other vertically. In addition, a touching electrode supporter 40 is disposed on the bottom surface of the upper substrate 14, which is positioned between the top touching electrode 36 and the upper substrate 14 and has a first thickness H₁. The top touching electrode 36 and the bottom touching electrode 38 have a first sensor gap P1 therebetween. In another aspect, each warning sensor 24 comprises a top warning electrode 42 and a bottom warning electrode 46 respectively disposed on the bottom surface of the upper substrate 12 and on the top surface of the lower substrate 14. The top warning electrode 42 and the bottom warning electrode 46 correspond to each other vertically. A warning electrode supporter 44 is disposed between the top warning electrode 42 and the upper substrate 14 and has a second thickness H₂. Besides, the top warning electrode 42 and the bottom warning electrode 46 has a second sensor gap P2 therebetween. In a preferable embodiment, the touching electrode supporter 40 and the warning electrode supporter 44 may be formed with patterned photoresist spacers respectively. As shown in FIG. 2, the first thickness H₁ is obviously larger than the second thickness H₂, thus the top touching electrode 36 is closer to the lower substrate 16 than the top warning electrode 42, which means the first sensor gap P1 is smaller than the second sensor gap P2. In a preferable embodiment, the second sensor gap P2 is about 1.1 times to about 10 times larger than the first sensor gap P1, and preferably is about 1.2 times to about 5 times larger than the first sensor gap P1. Under this design, when an external force is applied onto the surface of the touch panel 12, it is easier for the top touching electrode 36 to contact the bottom touching electrode 38 than the top warning electrode 42 resulting from the press of the external force, so as to produce touching control signals. On the other hand, when the external force applied onto the touch panel 12 reaches a predetermined strength such that the upper substrate 14 is further pressed downward and even more deformed, the warning sensor 24 with the larger second sensor gap P2 will be turned on, which means the top warning electrode 44 will contact the bottom warning electrode 46 resulting from the downward deformation of the upper substrate 14 to output a readout signal. Then, the readout signal will be transferred to the readout circuit unit 30 through the corresponding readout line 32. Therefore, the design of the warning sensor 24 with the second sensor gap P2 larger than the first sensor gap P1 provides a warning function of too strong external force.

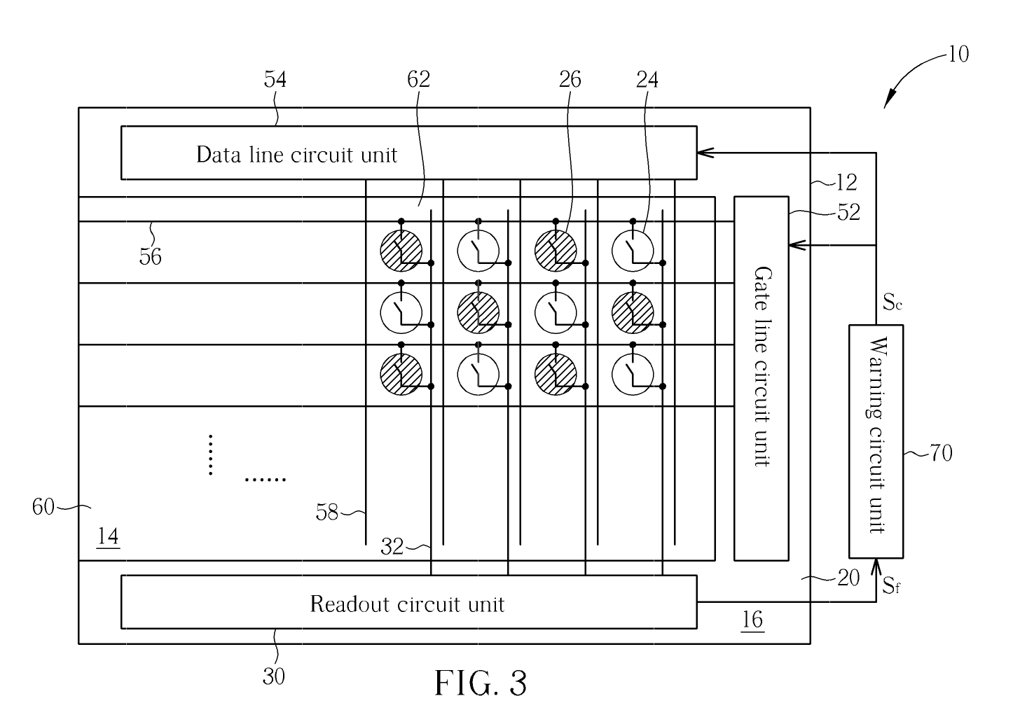

FIG. 3 is a schematic diagram of the top view of a second embodiment of the display device according to the present invention, wherein the same elements are represented with the same numerals used in the first embodiment. The present invention display device 10 comprises a touch panel 12, which is preferably an in-cell touch panel. As a result, the touch panel 12 is a touch display panel that integrates touch control function. The touch panel 12 comprises an upper substrate 14 and a lower substrate 16 disposed in parallel with each other, wherein the overlap portion of the upper substrate 14 and lower substrate 16 is defined as a display area 60, and the periphery part of the lower substrate 16 not covered by the upper substrate 14 is defined as a periphery circuit area 20. Since the touch panel 12 is an in-cell touch panel, it may be any kind of flat display panels, such as, but not limited to, a liquid crystal display (LCD) panel, an organic electroluminescent display panel, a plasma display panel, or an electrophoretic display panel. Therefore, the upper substrate 14 and the lower substrate 16 may be the color filter glass substrate and array glass substrate respectively of the LCD panel for instance, while the display material layer (not shown) disposed between the upper substrate 14 and lower substrate 16 may be a liquid crystal (LC) layer. The display device 10 further comprises a readout circuit unit 30, a gate line circuit unit 52, and a data line circuit unit 54, preferably disposed in the periphery circuit area 20. In addition, there are a plurality of readout lines 32, a plurality of gate lines 56, and a plurality of data lines 58 disposed on the lower substrate 16, electrically connected to the readout circuit unit 30, the gate line circuit unit 52, and the data line circuit unit 54 respectively. The gate lines 56 are perpendicular to the readout lines 32 and data lines 58. The perpendicular gate lines 56 and the data lines 58 define a plurality pixel regions 62 arranged as an array. In this embodiment, each warning sensor 24 is electrically connected to a corresponding gate line 56 and a corresponding readout line 32. As a result, the gate lines 56 replace the selecting lines 34 in the first embodiment.

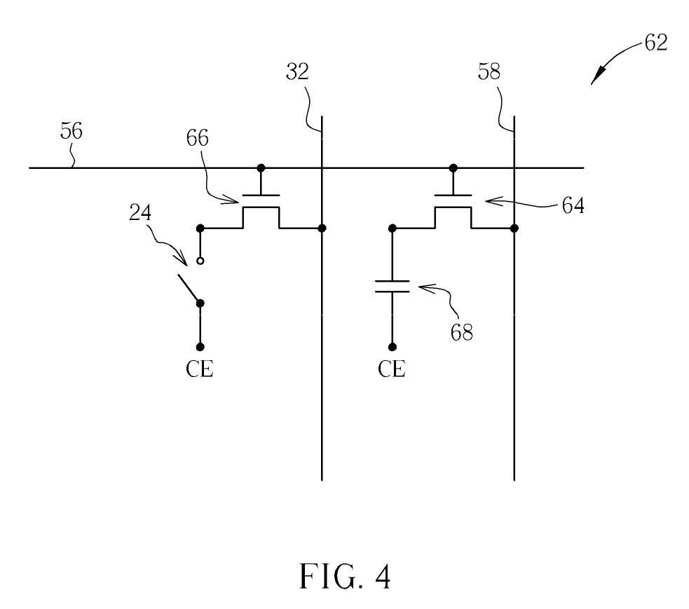

FIG. 4 is an equivalent circuit diagram of the pixel structure of one pixel region 62 shown in FIG. 3. The touch panel 12 comprises a plurality of pixel structures disposed in each pixel region 62. Each pixel structure comprises a gate line 56, a data line 58, at least an LC capacitor 68 and a pixel transistor 64, which is preferable a TFT. The gate, source, and drain of the pixel transistor 64 are electrically connected to the gate line 56, the data line 58 and the upper electrode plate of the LC capacitor 68 respectively, and the lower electrode plate of the LC capacitor 68 is electrically connected to the common electrode CE of the touch panel 12. In addition, the warning sensors 24 and the touching sensors 26 may be alternatively or selectively disposed in the pixel regions 62. Therefore, when one warning sensor 24 is disposed in a pixel region 62, the pixel region 62 may further comprise a readout transistor 66, whose source, gate, and drain are electrically connected to the bottom warning electrode of the warning sensor 24, the gate line 56, and the readout line 32 respectively, while the top warning electrode of the warning sensor 24 is electrically connected to the common electrode CE.

Although FIG. 3 shows that each pixel region 62 has a warning sensor 24 or a touching sensor 26, the arrangement design of the present invention of the touching sensors 26 and warning sensors 24 are not limited to the disclosure in FIG. 3. For example, there may be only one warning sensors 24 arranged every three or more pixel regions 62. In addition, the arrangement locations of the data line circuit unit 54, the gate line circuit unit 52, and the readout circuit unit 30 and the relative location thereof are not limited to FIG. 3. For instance, the data line circuit unit 54 and the readout circuit unit 30 may be disposed at the same side of the display area 60. In other embodiments, the data line circuit unit 54 and the readout circuit unit 30 may be integrated in one single driving circuit chip.

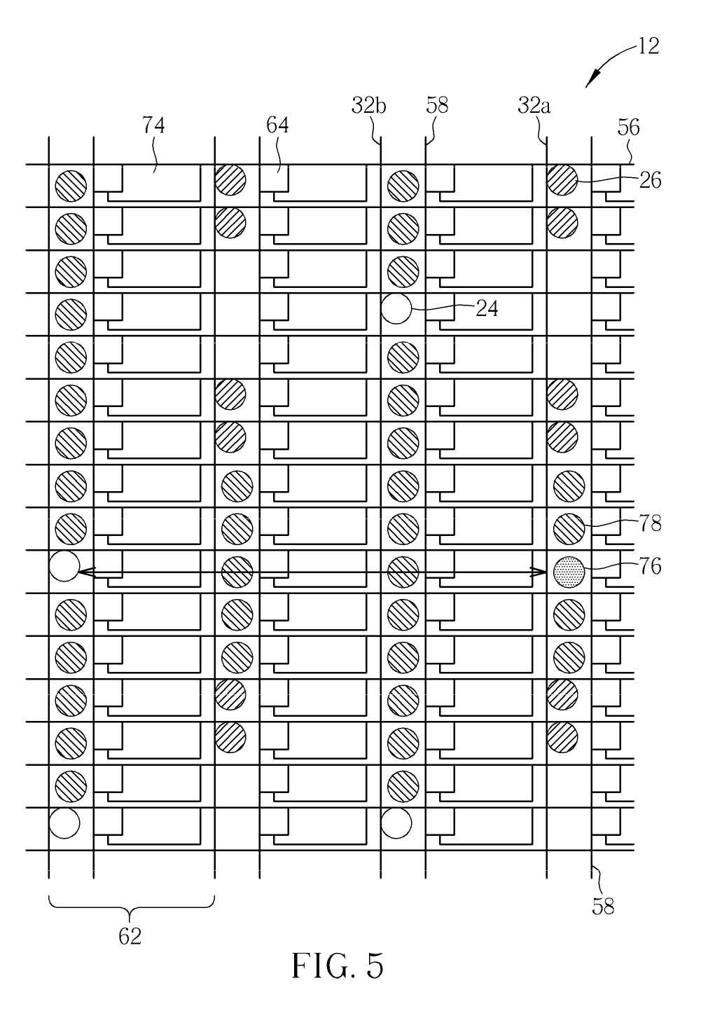

With reference to FIG. 5, FIG. 5 is a schematic diagram of the element layout according to a third embodiment of the display device of the present invention. The gate lines 56 of this embodiment replace the selecting lines in the first embodiment and are electrically connected to the warning sensors 24 and touching sensors 26, wherein the warning sensors 24 and touching sensors 26 are respectively positioned in different columns and are not electrically connected to the same readout lines. As shown in FIG. 5, each pixel region 62 has a gate line 56 and a data line 58 which are electrically connected to corresponding the pixel transistor 64. Each pixel region 62 further has a pixel electrode 74 electrically connected to the pixel transistor 64. Some touching sensors 26 may be placed in the same columns and electrically connected to the same first readout line 32a respectively. However, not every pixel region 62 in the above-mentioned columns has a touching sensor 26 disposed therein. For instance, in the most right column of FIG. 5, the intervals between some adjacent touching sensors 26 may be three to five pixel regions 62. Some pixel regions 62 may further have supporting elements 76 or sub-supporting elements 78 respectively, disposed between several adjacent touching sensors 26. On the other hand, the warning sensors 24 are arranged in other columns which have a plurality of sub-supporting elements 78 disposed in the same columns, and each warning sensor 24 is electrically connected to a second readout line 32b. Because the main functionality of the warning sensors 24 is to sense external force and determine if the external force meets a predetermined strength value, the amount of warning sensors 24 is much less that the amount of the touching sensors 26 in this embodiment. Furthermore, the arrangement design of the warning sensors 24 may be conformed to the arrangement of the supporting elements 76. For example, the warning sensors 24 and the supporting elements 76 may be positioned with an interval of three pixel regions 62 for example, as indicated by the arrow.

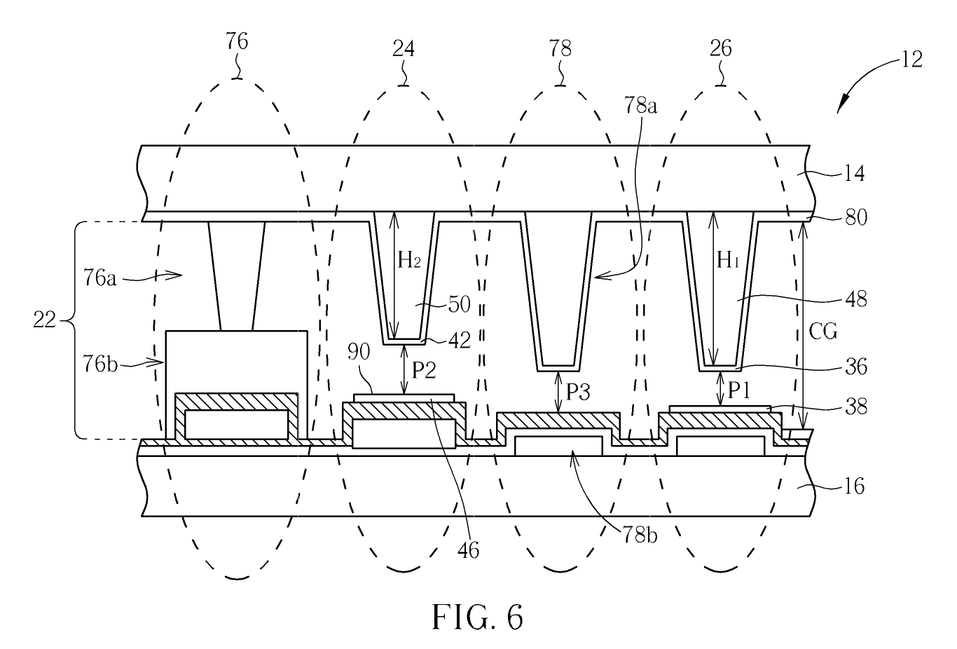

Referring to FIG. 6, FIG. 6 is a schematic diagram of the sectional view of the touch panel 12 shown in FIG. 5. In FIG. 6, the sectional structures of the warning sensor 24, the touching sensor 26, the supporting element 76, and the sub-supporting element 78 are shown wile the structures of the pixel electrodes 74 and pixel transistors 64 are omitted in FIG. 5. The in-cell touch panel 12 is a touch LCD panel for instance, and a display material layer 22, an LC layer, is disposed between the upper substrate 14 and the lower substrate 16. The touch panel 12 comprises at least a first photoresist spacer 48 and at least a second photoresist spacer 50 disposed between the upper substrate 14 and the top touching electrode 36 between and the upper substrate 14 and the top warning electrode 42 respectively, wherein the first photoresist spacer 48 and the second photoresist spacer 50 serve as the touching electrode supporter and the warning electrode supporter mentioned in the first embodiment. The thickness H₁ of the first photoresist spacer 48 is larger than the thickness H₂ of the second photoresist spacer 50. Accordingly, the first sensor gap P1 between the top touching electrode 36 and the bottom touching electrode 38 is less than the second sensor gap P2 between the top warning electrode 42 and the bottom warning electrode 46. Preferably, the second sensor gap P2 is about 1.1 to about 10 times larger than the first sensor gap P1. It should be noted that there is a common electrode 80 disposed on the bottom surface of the upper substrate 14, which is preferably a transparent conductive layer, comprising portions covering the surfaces of the first and second photoresist spacers 48, 50. Therefore, the top touching electrode 36 and the top warning electrode 42 respectively comprise a portion of the common electrode 80. Furthermore, on the top surface of the lower substrate 16 has a patterned transparent conductive layer 90, and the bottom touching electrode 38 and the bottom warning electrode 46 respectively comprise a portion of the patterned transparent conductive layer 90, wherein the patterned transparent conductive layer 90 and the pixel electrode 74 may be formed through the same fabrication process and with the same materials. In another aspect, the supporting element 76 is disposed between the upper substrate 14 and the lower substrate 16. In this embodiment, the supporting element 76 comprises an upper supporting structure 76a and a lower supporting structure 76b disposed on the surfaces of the upper substrate 14 and the lower substrate 16 respectively. The upper supporting structure 76a and the lower supporting structure 76b contact each other vertically to define the cell gap CG of the touch panel 12. However, in other embodiments, the supporting element 76 may only comprise a single supporting structure, such as a photoresist spacer, disposed on the bottom surface of the upper substrate 14 and expending downward to contact other elements on the surface of the lower substrate 16. The sub-supporting element 78 comprises a top sub-supporting structure 78a and a bottom sub-supporting structure 78b, respectively disposed on the surfaces of the upper substrate 14 and the lower substrate 16, which have a supporting gap P3 therebetween. The top sub-supporting structure 78a may comprise a portion of the common electrode 80 and a patterned photoresist spacer, and the supporting gap P3 is less than the second sensor gap P2, but a little larger than the first sensor gap P1. Accordingly, when an external force is applied onto the touch panel 12 to deform the upper substrate 14 downward, at first, the top touching electrode 36 will contact the bottom touching electrode 38 such that the touching sensor 26 will be turned on to produce a touch-control signal. In addition, when the external force is larger, the top sub-supporting structure 78a will further moved downward to contact the bottom sub-supporting structure 78b to provide a support force to the touch panel 12 in order to prevent the touch panel 12 from being operated abnormally under larger external force. Furthermore, when the external force is even much larger to reach a predetermined strength, the top warning electrode 42 will also be moved downward to contact the bottom warning electrode 46 so as to turn on the warning sensor 24. Accordingly, the display device having the touch panel 12 will produce a warning instruction for warning the user to reduce the external force, or the touch panel 12 may be damaged.

Regarding the method of warning the user to reduce the external force by the display device 10, FIG. 3 shows more details of the elements of the display device 10. As shown in FIG. 3, the present invention display device 10 further comprises a warning circuit unit 70, which may be disposed on the touch panel 12 or on an external circuit out of the touch panel 12. The warning circuit unit 70 is electrically connected to the readout circuit unit 30, and may be electrically connected to the data line circuit unit 54 and the gate line circuit unit 52. When the warning sensor 24 is turned on to output a readout signal to the readout circuit unit 30, the readout circuit unit 30 will output a feedback signal S_{f} to the warning circuit unit 70 which will control the touch panel 12 to send a warning signal for indicating the user that the external force is too strong after it receives the feedback signal S_{f}. For instance, the warning circuit unit 70 may output a control signal S_{c} to the gate line circuit unit 52 or the data line circuit unit 54 so as to control the touch panel 12 to display the above-mentioned warning signal in the display area 60.

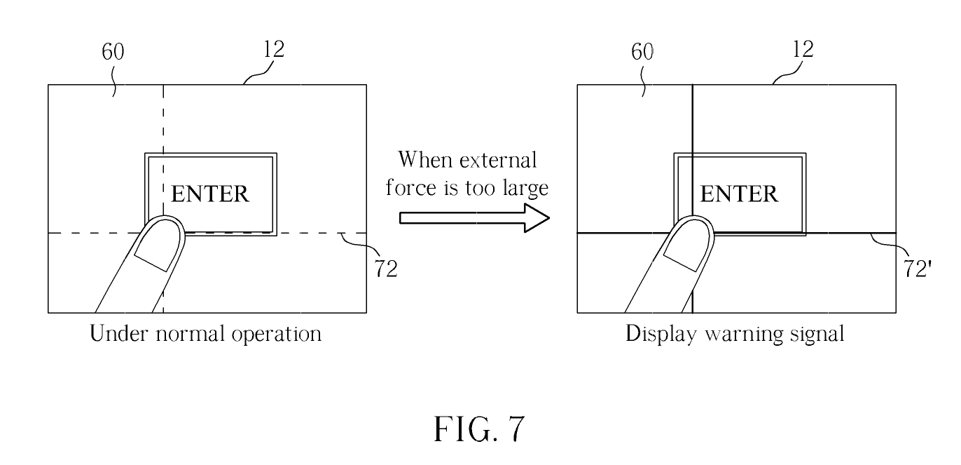

With reference FIG. 7, FIG. 7 is a schematic diagram of an embodiment of the present invention display device 10 showing the above-mentioned the warning signal when the external force is too large. As shown in the left diagram, under a normal operation, the pressing instruction line 72 is shown with light color or with dotted line in the display area 60 when the user press the touch panel 12 so that the user could realize that the touch panel 12 has read out the pressing point or received his instruction. On the other hand, the right diagram shows the situation that the external force applied by the user is too large. When the external force is too large, the warning sensor 24 will be turned on such that the warning circuit unit 70 will control the touch panel 12 to produce a warning signal. For example, the touch panel 12 may show a broad, dark, or solid pressing instruction line 72′ to warn the user to reduce the pressing force. However, warning signals for indicating that the external force is too large of the present invention is not limited to the disclosure in FIG. 7, and may be shown as text signals or voice or sound instruction signals for instance.

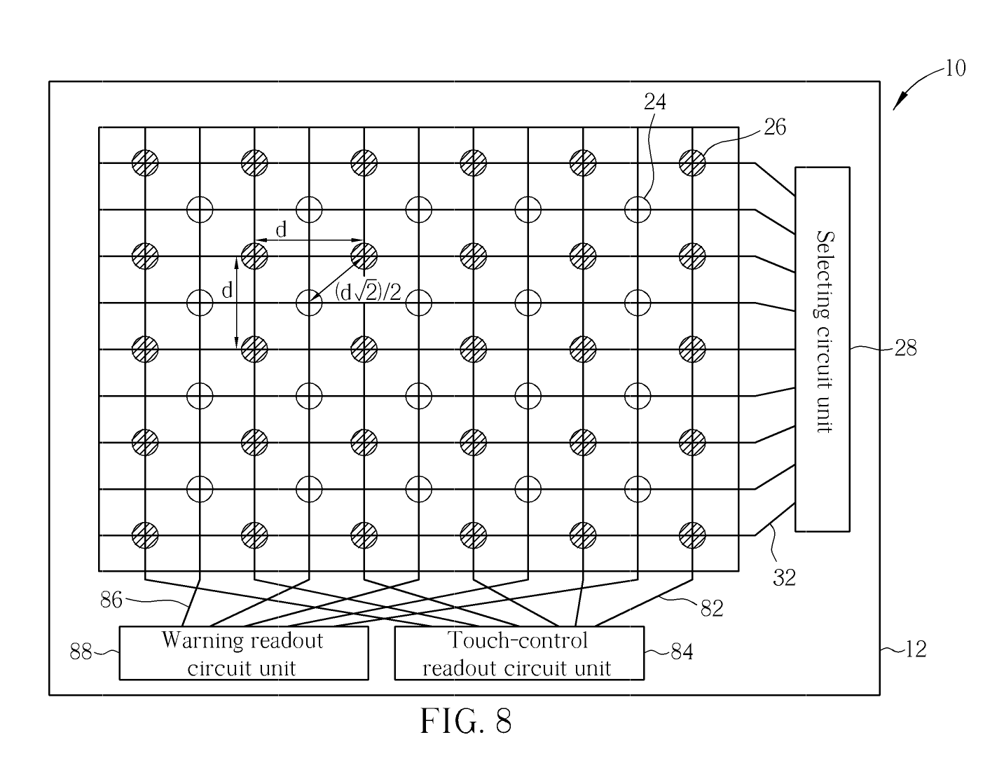

Referring to FIG. 8, FIG. 8 is a schematic diagram of the element layout of the display device according to a fourth embodiment of the present invention. In accordance with the spirit of the present invention, the amount and disposing intervals of the warning sensors in the touch panel may be various and adjusted basing on the size of the touch panel, the pixel size, the pressing area of the touch media, the structure design of the warning sensor, and practical requirement of the warning sensors so as to optimize the whole design and structure of the touch panel in order to provide effective warning mechanism and preferable aperture ratio. The present invention touch panel 12 shown in FIG. 8 is an in-cell touch panel, which is disposed in a display device 10 and comprises a plurality of touching sensors 26 and warning sensors 24. The touching sensors 26 and the warning sensors 24 are respectively arranged in different rows and columns, thus they do not have common selecting lines 32 or readout lines. For example, the touching sensors 26 in the same columns are all electrically connected to the same sensing readout lines 82 respectively, which extend vertically, wherein the sensing readout lines 82 are electrically connected to the touch-control readout circuit unit 84, and the warning sensors 24 in the same columns are electrically connected to the same warning readout lines 86 substantially parallel to the sensing readout lines 82. The warning readout lines 86 are electrically connected to the warning readout circuit unit 88. As a result, the warning readout circuit unit 88 and the touch-control readout circuit unit 84 respectively process the readout signals from the warning sensors 24 and the touching sensors 26. However, in other embodiments, the sensing readout lines 82 and the warning readout lines 86 may be all electrically connected to the same readout circuit unit.

Generally, if the touch panel 12 has one warning sensor 24 disposed at a side of each touching sensor 26, it could have a best sensitivity for sensing force strength and provide best protection functionality. However, in collocation with aperture ratio requirement, the amount of the warning sensors 24 is not equal to that of the touching sensors 26, which means not every touching sensor 26 is accompanied with a warning sensor 24 in this embodiment. For instance, in consideration with the standard stylus size of a touch pen as the pressing area of the touch panel 12 and defining the distance of two adjacent touching sensors 26 as “d”, the preferable distance of the warning sensor 24 and its adjacent touching sensor 26 is about (d√2)/2.

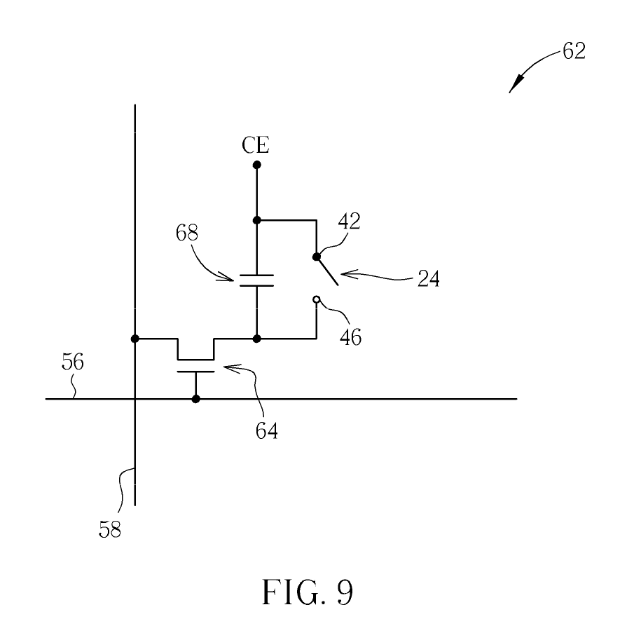

With reference to FIG. 9, FIG. 9 is an equivalent circuit diagram of a pixel structure of the touch panel according to a fifth embodiment of the present invention. The touch panel of this embodiment is an in-cell touch panel, comprising a plurality of pixel regions 62, each of which is defined by a gate line 56 and a data line 58. The touching sensors (not shown) and warning sensors 24 are arranged in different pixel regions 62 and have a common gate line 56 and a data line 58 of the corresponding pixel region 62 with the other display electric elements in the same pixel region 62, and are controlled by the pixel transistor 64 in that pixel region 62. For example, the bottom warning electrode 46 of the warning sensor 24 and the bottom electrode plate of the LC capacitor 68 are electrically connected to the drain of the pixel transistor 64, and the top warning electrode 42 and the upper electrode plate of the LC capacitor 68 are both electrically connected to the common electrode CE. On the other hand, in other pixel regions 62 with the touching sensors, the electrical connection of the touching sensor is similar to that of the warning sensor 24 shown in FIG. 9. Therefore, each pixel region 62 comprises a pixel transistor 64 and an LC capacitor 68, and selectively comprises a warning sensor 24 or a touching sensor. As a result, a conventional touch panel only having touching sensors can be modified to replace some touching sensors in the pixel regions 62 with the warning sensors 24 of the present invention, provided that the sensor gap of the warning sensors 24 is larger than the sensor gap of the touching sensors.

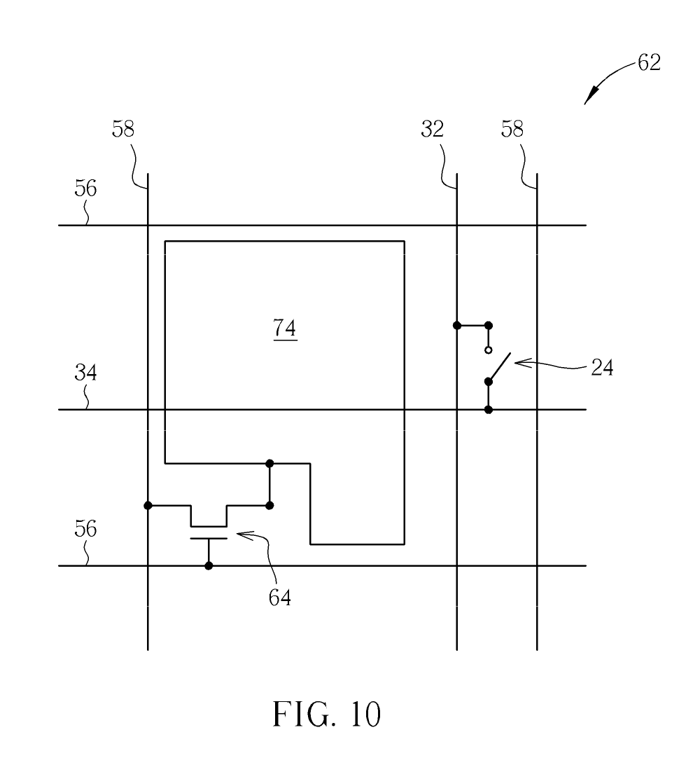

Referring to FIG. 10, FIG. 10 is an equivalent circuit diagram of a pixel structure of the touch panel according to a sixth embodiment of the present invention. In this embodiment, each pixel region 62 only comprises a warning sensor 24 or a touching sensor (not shown), and the warning sensor 24 or touching sensor is electrically connected to a corresponding readout line 32 and a corresponding selecting line 34, but not to the data line 58 and gate line 56 that are electrically connected to the pixel transistor 64. Therefore, the pixel region 62 having the warning sensor 24 comprises a gate line 56 and a selecting line 34 substantially in parallel to each other and a data line 58 and a readout line 32 substantially in parallel to the data line 58 at the same time.

In contrast to the prior art, the present invention display device or touch panel comprises at least a warning sensor. When the external force applied onto the touch panel reaches a predetermined strength, the top warning electrode and the bottom warning electrode will contact with each other to turn on the warning sensor so as to output a readout signal, such that the display device can output a warning signal for warning the user that the external force is too large, in order to avoid the touch panel to be damaged caused by the large external force. In accordance with the spirit of the present invention, the design of the warning sensor is based on providing a different sensor gap between the sensing electrodes from those of other sensors, such as touching sensors, so as to practice the warning sensing mechanism. When the touch panel comprises a plurality of warning sensors, the warning sensors may have various sensor gaps at the same time. For example, the touch panel could be designed to produce different warning signals when different warning signals with various sensor gaps are turned on individually. In addition, the circuit design between warning sensors, touching sensors, pixel transistors, LC capacitors, readout lines, selecting lines, gate lines, data lines, or circuit units for receiving signals are not limited to the above-disclosed embodiments. Any touch panel or display device comprising at least a warning sensor designed in accordance with providing a different sensor gap should belong to the scope of the present invention.

Those skilled in the art will readily observe that numerous modifications and alterations of the device and method may be made while retaining the teachings of the invention.

What is claimed is:

1. A touch panel, comprising:
an upper substrate and a lower substrate disposed in parallel with each other;
at least a touching sensor, comprising:
a top touching electrode, disposed on a bottom surface of the upper substrate; and
a bottom touching electrode, disposed on an top surface of the lower substrate and corresponding to the top touching electrode, the top touching electrode and the bottom touching electrode having a first sensor gap therebetween; and
at least a warning sensor, comprising:
a top warning electrode, disposed on the bottom surface of the upper substrate; and
a bottom warning electrode, disposed on the top surface of the lower substrate and corresponding to the top warning electrode, the top warning electrode and the bottom warning electrode having a second sensor gap, the second sensor gap being larger than the first sensor gap;
wherein when an external force applied onto the touch panel reaches a predetermined strength, the top warning electrode contacts the bottom warning electrode to make the warning sensor output a readout signal to indicate the external force is too large.

2. The touch panel of claim 1, wherein the second sensor gap is about 1.1 times to about 10 times larger than the first sensor gap.

3. The touch panel of claim 1, further comprising a least a first spacer and at least a second spacer disposed between the upper substrate and the top touching electrode and between the upper substrate and the top warning electrode respectively, and a thickness of the first spacer being larger than a thickness of the second spacer.

4. The touch panel of claim 1, further comprising a common electrode disposed on the bottom surface of the upper substrate, and the top touching electrode and the top warning electrode comprise a portion of the common electrode respectively.

5. The touch panel of claim 1, further comprising a patterned transparent conductive layer disposed on the top surface of the lower substrate, and the bottom touching electrode and the bottom warning electrode comprise a portion of the patterned transparent conductive layer respectively.

6. The touch panel of claim 1, further comprising at least a selecting line, and both the touching sensor and the warning sensor being electrically connected to the selecting line.

7. The touch panel of claim 1, further comprising at least a readout line, and both the touching sensor and the warning sensor being electrically connected to the readout line.

8. The touch panel of claim 1, further comprising a plurality of supporting elements disposed between the upper substrate and the lower substrate, and the supporting elements defining a cell gap of the touch panel.

9. The touch panel of claim 1, further comprising at least a sub-supporting element having a top sub-supporting structure and a bottom sub-supporting structure disposed on the bottom surface of the upper substrate and on the top surface of the lower substrate respectively, and the top sub-supporting structure and the bottom sub-supporting structure having a supporting gap therebetween, wherein the first sensor gap is smaller than the supporting gap, and the second sensor gap is larger than the supporting gap.

10. A display device, comprising:
a touch display panel, comprising:
an upper substrate and a lower substrate disposed in parallel with each other;
at least a touching sensor, comprising:
a top touching electrode, disposed on a bottom surface of the upper substrate; and
a bottom touching electrode, disposed on a top surface of the lower substrate and corresponding to the top touching electrode, the top touching electrode and the bottom touching electrode having a first sensor gap therebetween; and
at least a warning sensor, comprising:
a top warning electrode, disposed on the bottom surface of the upper substrate; and
a bottom warning electrode, disposed on the top surface of the lower substrate and corresponding to the top warning electrode, the top warning electrode and the bottom warning electrode having a second sensor gap therebetween, the second sensor gap being larger than the first sensor gap, wherein when an external force applied onto the touch display panel reaches a predetermined strength, the top warning electrode contacts the bottom warning electrode to make the warning sensor output a readout signal;
a readout circuit unit, used for receiving the readout signal and outputting a feedback signal; and
a warning circuit unit, used for controlling the touch display panel to output a warning signal indicating that the external force is too large when the warning circuit unit receives the feedback signal.

11. The display device of claim 10, wherein the touch display panel further comprises a display area and the warning circuit unit is capable of controlling the touch display panel to display the warning signal.

12. The display device of claim 10, wherein the warning signal comprises a sound instruction signal.

13. The display device of claim 10, wherein the second sensor gap is about 1.1 times to about 10 times larger than the first sensor gap.

14. The display device of claim 10, further comprising at least a first spacer and at least a second spacer disposed between the upper substrate and the top touching electrode and between the upper substrate and the top warning electrode respectively, and a thickness of the first spacer is larger than a thickness of the second spacer.

15. The display device of claim 10, further comprising a common electrode disposed on the bottom surface of the upper substrate, and the top touching electrode and the top warning electrode comprise a portion of the common electrode respectively.

16. The display device of claim 10, further comprising a patterned transparent conductive layer disposed on the top surface of the lower substrate, and the bottom touching electrode and the bottom warning electrode comprise a portion of the patterned transparent conductive layer respectively.

17. The display device of claim 10, further comprising at least a selecting line, and both the touching sensor and the warning sensor being electrically connected to the selecting line.

18. The display device of claim 10, further comprising at least a readout line, and both the touching sensor and the warning sensor being electrically connected to the readout line.

19. The display device of claim 10, further comprising a plurality of supporting elements disposed between the upper substrate and the lower substrate, the supporting elements define a cell gap of the touch display panel.

20. The display device of claim 10, further comprising at least a sub-supporting element, having a top sub-supporting structure and a bottom sub-supporting structure disposed on the bottom surface of the upper substrate and on the top surface of the lower substrate respectively, and the top sub-supporting structure and the bottom sub-supporting structure having a supporting gap therebetween, wherein the first sensor gap is smaller than the supporting gap, and the second sensor gap is larger than the supporting gap.

21. An in-cell touch panel, comprising:
an upper substrate and a lower substrate disposed in parallel with each other, the lower substrate comprising a display area;
a display material layer disposed between the upper substrate and the lower substrate;
a plurality of pixel structures disposed in the display area, each of the pixel structures comprising:
a gate line and a data line disposed on the lower substrate; and
a thin film transistor (TFT) electrically connected to the gate line and the data line;
at least a touching sensor comprising:
a top touching electrode, disposed on a bottom surface of the upper substrate; and
a bottom touching electrode, disposed on a top surface of the lower substrate and corresponding to the top touching electrode, the top touching electrode and the bottom touching electrode having a first sensor gap therebetween; and
at least a warning sensor comprising:
a top warning electrode, disposed on the bottom surface of the upper substrate; and
a bottom warning electrode, disposed on the top surface of the lower substrate and corresponding to the top warning electrode, the top warning electrode and the bottom warning electrode having a second sensor gap therebetween, the second sensor gap being larger than the first sensor gap;
wherein when an external force applied onto the in-cell touch panel reaches a predetermined strength, the top warning electrode contacts the bottom warning electrode to make the warning sensor output a readout signal to indicate the external force is too large.

22. The in-cell touch panel of claim 21, wherein when the warning sensor outputs the readout signal, the display area of the in-cell touch panel displays a warning signal.
